(19) United States
(12) Patent Application Publication
(10) Pub. No.: US 2011/0061520 A1
(43) Pub. Date: Mar. 17, 2011

(54) AIR PLOW

(76) Inventor: PETER URBACH, Santa Monica, CA (US)

(21) Appl. No.: 12/877,197

(22) Filed: Sep. 8, 2010

Related U.S. Application Data
(60) Provisional application No. 61/242,197, filed on Sep. 14, 2009.

(51) Int. Cl. A01B 3/00; A01B 61/00; F41H 11/12

(52) U.S. Cl. 89/1.13; 172/292

(57) ABSTRACT

An airborne plow is provided for destroying unwanted vegetation and for clearing mines which includes an elongated arm. A mechanism on the elongated arm is for engaging with the unwanted vegetation. Another mechanism is for suspending the elongated arm from the underside of a helicopter or a slow flying object. The helicopter can maneuver the elongated arm, so that the engaging mechanism can plow the unwanted vegetation, opium plant and the unwanted mines.

### CROSS-REFERENCE TO RELATED APPLICATION

This application claims the benefit of Provisional Patent Application No. 61/242,197, filed on Sep. 14, 2009, in the United States Patent & Trademark Office, the disclosure of which is incorporated herein by reference.

### BACKGROUND OF THE INVENTION

1. Field of the Invention

The present invention relates to a plow, and more particularly, an airborne plow for destroying unwanted vegetation or clearing mines.

The airborne plow provides a simple, cost-effective, and environmentally sound way of destroying unwanted or illegal vegetation or clearing mines. The airborne plow will be suspended from the bottom of a helicopter or a slow flying object to safely assist farmers or law enforcement personnel in destroying the vegetation, so that the vegetation cannot be restored or harvested. The airborne plow is ideal for destroying opium, coca, marijuana, and other illegal crops. The airborne plow enables the cultivation and flow of illegal drugs to be attacked at its source, without using poisons or endangering the welfare of those destroying the vegetation.

2. Description of the Prior Art

The use of chemical spraying to defoliate and eradicate unwanted vegetation or the cultivation of illegal drugs has proven to be expensive and poisonous to the environment. There have also been instances where contaminated crops are harvested regardless, causing cancer and defects to those who come in contact with it. Attempting to destroy these crops can be an extremely dangerous process. Law enforcement and military personnel are always in danger of being injured or killed by drug traffickers during attempts to wipe out a crop. The flow of illegal drugs has always been a significant concern. A safer, more effective way is needed.

Numerous innovations for aircraft towing devices have been provided in the prior art that will be described. Even though these innovations may be suitable for the specific individual purposes to which they address, however, they differ from the present invention.

A FIRST EXAMPLE, U.S. Patent Office Document No. 3,942,748, Issued on Mar. 9, 1976, to Wolkovitch teaches an apparatus for controlling the distance between a vehicle to which it is attached and a surface over which the vehicle may be moving. The apparatus includes a cable and a sheet member which in a first mode is in contact with the surface but in a second mode is out of contact with the surface. Because of design, the sheet member induces a greater tension in the cable when in the second mode than when in the first mode; the increase in tension may be used to actuate a control or indicating devices on the vehicle to maintain the distance within desired limits.

A SECOND EXAMPLE, U.S. Patent Office Document No. 4,554,781, Issued on Nov. 26, 1985, to Rogers teaches a tree trimmer apparatus for installation on a helicopter or the like including a boom hanging vertically downward from the helicopter carrying a plurality of circular saws arranged with their blades nearly adjacent over a length of at least twenty feet on the boom, which is attached to the helicopter in a manner to be constrained against rotation about a vertical axis and to have rotational movement about a horizontal axis at right angles to the normal direction of motion of the helicopter; the blades are preferably powered by a hydraulic motor with groups of five 24-inch blades being driven through belts by one hydraulic motor provided with hydraulic fluid under pressure from a pump in the helicopter. A foot at the bottom of the boom extends to the rear and permits the apparatus to be landed with the bottom of the boom on a landing surface by maneuvering the helicopter backward to lay the boom and saw blades on the ground in front of the helicopter. A pusher rod extends downward from an arm on the top of the boom to push tree branches off of or away from a power line as the branches are being cut; a quick release hook between the top of the boom structure and the helicopter and quick release hydraulic connections permit the apparatus to be dropped in an emergency.

A THIRD EXAMPLE, U.S. Pat. Office Document No. 5,183,119, Issued on Feb. 2, 1993, to Wattenburg teaches an anti-snag plowing system suitable for clearing mines in the Middle East is disclosed. Advantageously, the plowing system has also been found to be an efficient and effective soil conditioner, making it a useful farming tool as well. The plowing system comprises several digging-knife units, or plows, and a harrow. Both are attached in tandem to a chain matrix, which is pulled with either a helicopter or tractor. The digging-knife units rotate if the digging-knives hit an immovable snag. The harrow is covered with a chain blanket, and may have magnetic or sonic wave mine triggers if the system is used for clearing mines. A symmetrical embodiment is also disclosed.

A FOURTH EXAMPLE, U.S. Patent Office Publication No. 2003/0034778, published on Feb. 20, 2003, to Nelson teaches a metal detector system including a chassis for supporting electromagnetic sensor components above a medium such as soil or water. A transmitter coil and two receiver coils are attached to the chassis. A propulsion system is attached to the chassis between or adjacent to the receiver coils. The location of the propulsion system causes electromagnetic interference signals emanating from the propulsion system to be received at a nominally equal magnitude by each of the receiver coils.

A FIFTH EXAMPLE, U.S. Patent Office Publication No. 2004/0000409, published on Jan. 1, 2004, to Abbott teaches a method for containing forest fires involves cutting a swath of trees and shrubs surrounding the fire area with use of an aerial saw carried by a helicopter. The swath of cut trees and shrubs is then watered down or covered by flame retardants. The aerial saw is preferably a rotary bladed one suspended horizontally from the helicopter.

It is apparent now that numerous innovations for aircraft towing devices have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide an airborne plow for destroying unwanted vegetation that avoids the disadvantages of the prior art.

ANOTHER OBJECT of the present invention is to provide an airborne plow for destroying unwanted vegetation that is simple and inexpensive to manufacture.

STILL ANOTHER OBJECT of the present invention is to provide an airborne plow for destroying unwanted vegetation that is simple to use.

BRIEFLY STATED, STILL YET ANOTHER OBJECT of the present invention is to provide an airborne plow for destroying unwanted vegetation which comprises an elongated arm. A mechanism on the elongated arm is for engaging with the unwanted vegetation. Another mechanism is for suspending the elongated arm from the underside of a helicopter. The helicopter can maneuver the elongated arm, so that the engaging mechanism will destroy the unwanted vegetation.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a side perspective view showing the present invention being used by three helicopters;

FIG. 2 is a front perspective view showing the present invention suspended from one helicopter;

FIG. 3 is a perspective view showing the various components of the present invention separated;

FIG. 4 is an enlarged perspective view of the dotted area in FIG. 2 as indicated by arrow 4; and

FIG. 5 is an enlarged perspective view of the dotted area in FIG. 2 as indicated by arrow 5.

### REFERENCE NUMERALS UTILIZED IN THE DRAWING

110 airborne plow
112 unwanted vegetation or mine field
114 elongated arm of airborne plow 110
116 engaging mechanism of airborne plow 110
118 suspending mechanism of airborne plow 110
120 underside of helicopter 122
122 helicopter
124 I-beam for elongated arm 114
126 blade of engaging mechanism 116
128 leading edge of I-beam 124
130 spreader bar of suspending mechanism 118
132 chain of suspending mechanism 118
134 end of spreader bar 130
136 top end of I-beam 124
138 shock absorber of suspending mechanism 118
140 coil spring of shock absorber 138
142 top end of chain 132
144 set of double lugs of suspending mechanism 118
146 shear bolt of suspending mechanism 118
148 bottom end of chain 132
150 cotter pin of suspending mechanism 118
152 free end of shear bolt 146
154 attachment hardware for spreader bar 130

### DETAILED DESCRIPTION OF THE PREFERRED EMBODIMENT

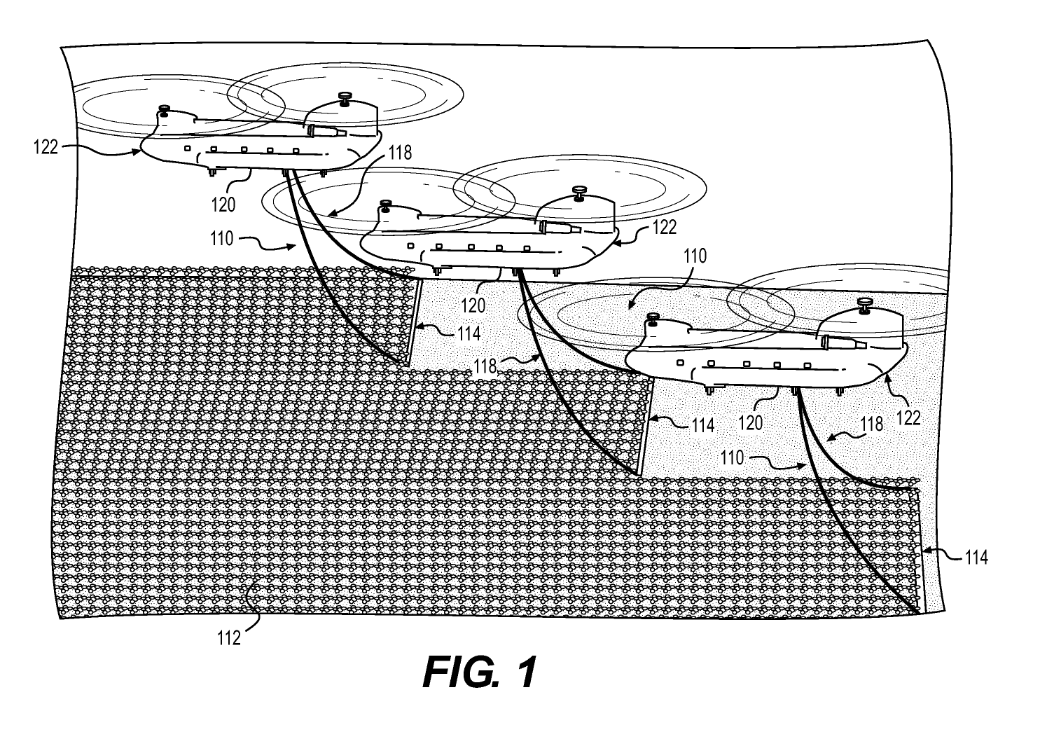

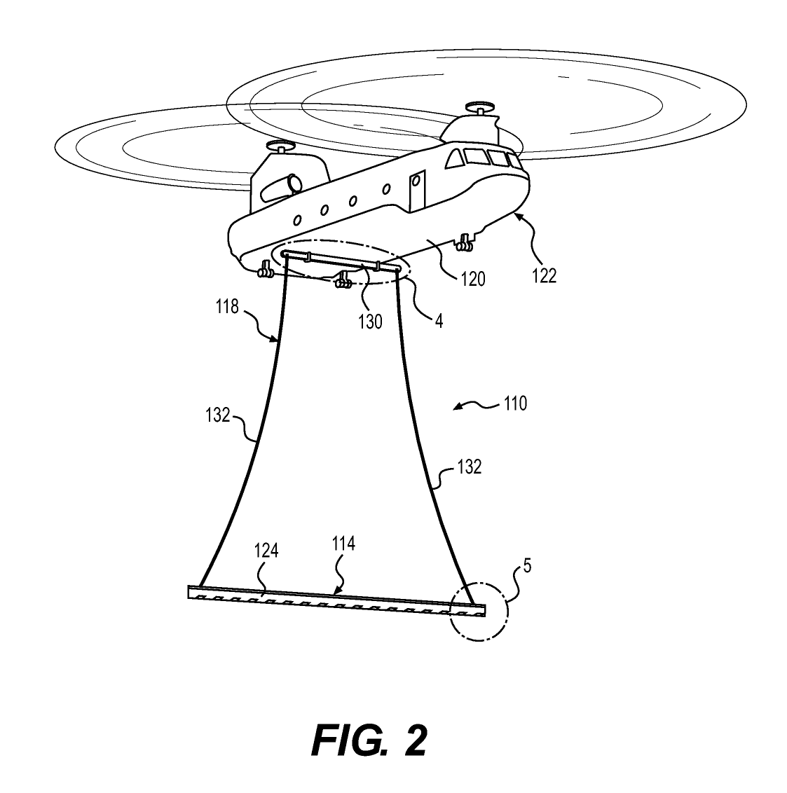

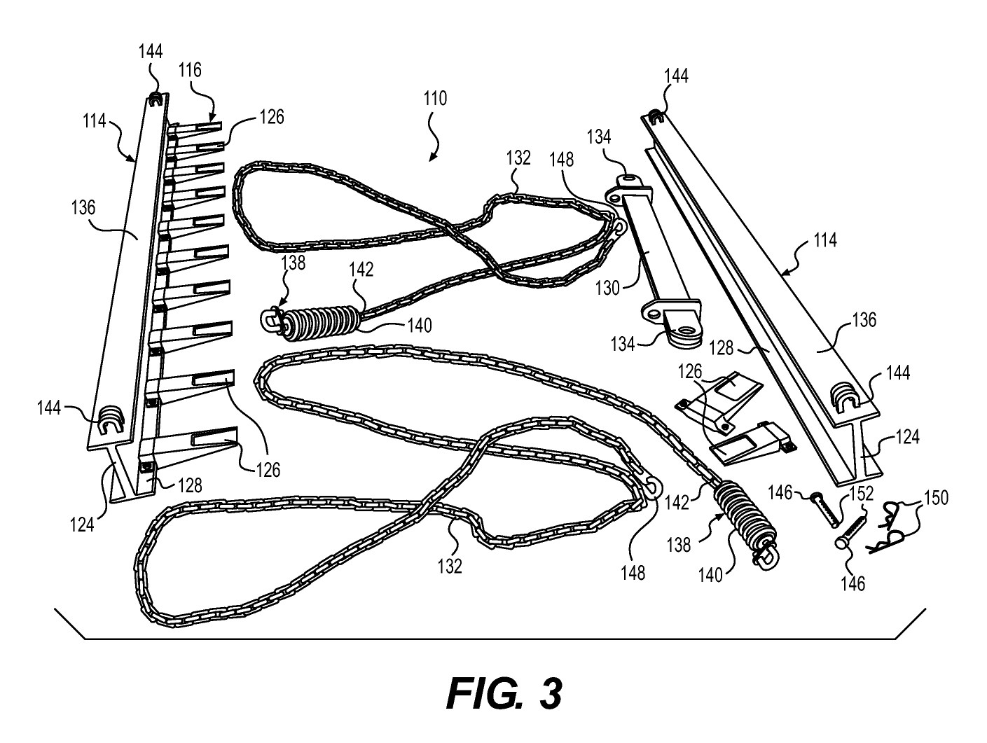

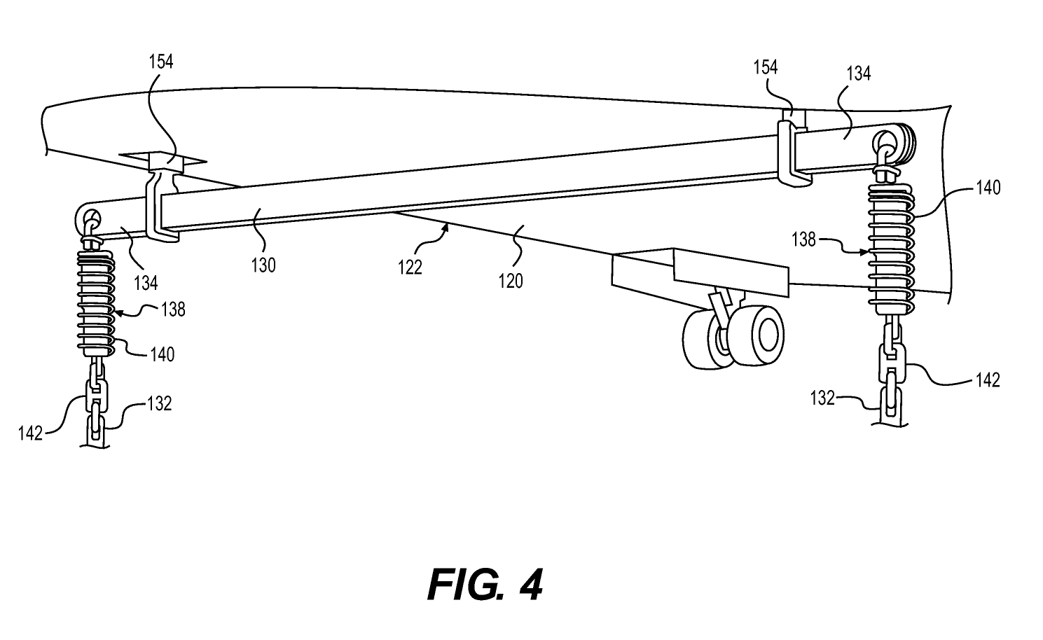

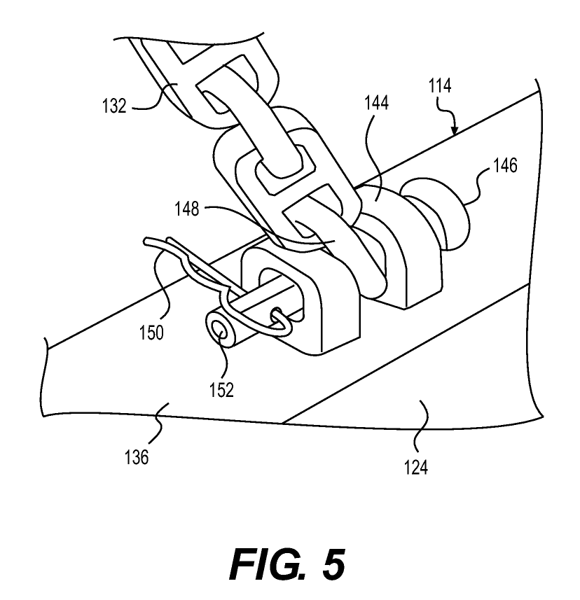

Referring now to the figures, in which like numerals indicate like parts, and particularly to FIGS. 1 through 5, and as such, will be discussed with reference thereto.

The present invention is an airborne plow 110 for destroying unwanted vegetation 112. The airborne plow 110 comprises an elongated arm 114 (we also can use multiple elongated arms 114 in parallel, one after the other one). A mechanism 116 on the elongated arm 114 is for engaging with the unwanted vegetation 112 (or mine field). Another mechanism 118 is for suspending the elongated arm 114 from the underside 120 of a helicopter 122 or a slow flying object. The length of the elongated arm 114 is at least five (05) times of the width of the helicopter 122. The length of the elongated arm 114 is at least 100 feet. The elongated arm 114 is made of steel. The helicopter 122 can maneuver the elongated arm 114, so that the engaging mechanism 116 will destroy the unwanted vegetation 112. The helicopter 122 is used because of its speed of plow and speed of flying to escape due to the danger or high risk at the illegal opium field or hostile mine field. Therefore, the helicopter 122 is used in place of a regular tractor or a bulldozer.

The elongated arm 114 is comprised out of an I-beam 124. The engaging mechanism 116 comprises a plurality of blades 126 spaced apart and attached to a leading edge 128 of the I-beam 124.

The suspending mechanism 118 comprises a spreader bar 130 removably connected to the underside 120 of the helicopter 122. A pair of chains 132 is provided. Each chain 132 extends between one end 134 of the spreader bar 130 and one top end 136 of the I-beam 124. The suspending mechanism 118 further comprises a pair of shock absorbers 138 with coil springs 140. Each shock absorber 138 is retained between a top end 142 of one chain 132 and one end 134 of spreader bar 130.

The suspending mechanism 118 still further comprises two sets of double lugs 144. Each set of double lugs 144 are formed on one top end 136 of the I-beam 124. A pair of shear bolts 146 is provided. Each shear bolt 146 extends through each set of double lugs 144 to hold a bottom end 148 of one chain 136 therebetween. A pair of cotter pins 150 is also provided. Each cotter pin 150 extends through a free end 152 of each shear bolt 146 to thereby provide a breakaway safety system for the helicopter 122 in case the I-beam 124 snags on an obstruction on the ground.

In summary the airborne plow 110 consists of an elongated arm 114 being an I-beam 124 with enough weight and geometry on the leading edge 128 to knock down and sufficiently destroy the unwanted vegetation 112 that can be used in the production of illegal drugs. The I-beam 124 is approximately twenty to fifty feet wide depending on the power and altitude requirements of the helicopter 122 that is towing it. The leading edge 128 of the I-beam 124 is configured with blades 126.

The I-beam 124 is suspended by two chains 132, with each chain 132 being approximately one hundred to one hundred and fifty feet in length. The length of the chains 132 may vary depending upon conditions. It is advantageous to use the chains 132 because the characteristic catenary curve of chains 132, provide additional shock absorbing capabilities. A spreader bar 130 prevents the chains 132 from twisting. A pair of shear bolts 146 provides breakaway safety to the helicopter, in case the I-beam 124 snags on an obstruction. A pair of shock absorbers 138 with coil springs 140, are each attached between a top end 142 of the chain 132 and one end 134 of the spreader bar 130. Attachment hardware 154 is included to connect the spreader bar 130 to the helicopter 122. When the I-beam 124 is towed by the helicopter 122, it will knock over and destroy the unwanted vegetation 112 (or clearing mines) by disturbing the ground, thus preventing the harvesting and later the processing of the unwanted vegetation 112. The airborne plow 110 can be used on a single helicopter 122 or in a wave of overlapping helicopters 122 or slow flying objects (e.g. hovercraft). The exact specifications of the present invention may vary.

It will be understood that each of the elements described above, or two or more together, may also find a useful application in other types of constructions differing from the types described above.

While the invention has been illustrated and described as embodiments of an airborne plow for destroying unwanted vegetation or clearing mines, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. An airborne plow for destroying unwanted vegetation, and unwanted mines which comprises:
a) an elongated arm;
b) means, on the elongated arm, for engaging with the unwanted vegetation;
c) means, for suspending the elongated arm from underside of a helicopter, whereby the helicopter can maneuver the elongated arm, so that the engaging means will destroy the unwanted vegetation;
d) wherein, the length of the elongated arm is at least five times of the width of the helicopter; and
e) the length of the elongated arm is at least 100 feet.

2. The airborne plow as recited in claim 1, wherein the elongated arm is comprised out of an I-beam.

3. The airborne plow as recited in claim 2, wherein the engaging means comprises a plurality of blades spaced apart and attached to a leading edge of the I-beam.

4. The airborne plow as recited in claim 2, wherein the suspending means comprises:
a) a spreader bar removably connected to the underside of the helicopter; and
b) a pair of chains, wherein each the chain extends between one end of the spreader bar and one top end of the I-beam.

5. The airborne plow as recited in claim 4, wherein the suspending means further comprises a pair of shock absorbers with coil springs, wherein each the shock absorber is retained between a top end of one the chain and the one end of the spreader bar.

6. The airborne plow as recited in claim 4, wherein the suspending means further comprises:
a) a pair of double lugs, wherein each the double lugs are formed on one top end of the I-beam;
b) a pair of shear bolts, wherein each the shear bolt extends through each the double lugs to hold a bottom end of one the chain thereto; and
c) a pair of cotter pins, wherein each the cotter pin extends through a free end of each the shear bolt, thereby providing a breakaway safety to the helicopter in case the I-beam snags on an obstruction on the ground.

7. The airborne plow as recited in claim 1, wherein multiple elongated arms can be used in parallel, one after the other one.
